(19) United States
(12) Patent Application Publication
(10) Pub. No.: US 2025/0356760 A1
(43) Pub. Date: Nov. 20, 2025

(54) SYSTEMS AND METHOD FOR PROVIDING A COLLABORATIVE MAP FOR AN AIRCRAFT

(71) Applicant: Airbus (S.A.S.), Blagnac Cedex (FR)

(72) Inventors: Pierre BIZET, Blagnac (FR); Jonathan RIGAUD, Blagnac (FR); Sebastien SERVOLES, Blagnac (FR); Pierre LUCE-VAYRAC, Blagnac (FR); Alain LAGARRIGUE, Blagnac (FR); Frederick GIANNI, Blagnac (FR)

(21) Appl. No.: 19/211,824

(22) Filed: May 19, 2025

Related U.S. Application Data
(60) Provisional application No. 63/649,727, filed on May 20, 2024.

(51) Int. Cl. G08G 5/23; G08G 5/21; G08G 5/265; G08G 5/34; G08G 5/51; G08G 5/59; G08G 5/76

(52) U.S. Cl. CPC G08G 5/23; G08G 5/21; G08G 5/265; G08G 5/34; G08G 5/51; G08G 5/59; G08G 5/76

(57) ABSTRACT

A communication system is disclosed herein and includes aircraft equipment and on-ground equipment and uses a collaborative map, which has a graphic user interface that includes digital layers that each display a different interface view, and a digital assistant to optimize missions of the aircraft on ground and in flight. A first instance of the collaborative map and a first instance of the digital assistant are onboard the aircraft for one or more pilots to view and interact with. At least one second instance of the collaborative map and a second instance of the digital assistant are on-ground for one or more operators to view and interact with. Communications are managed to ensure synchronization of the instances of the collaborative map and the instances of the digital assistant.

### CROSS-REFERENCE TO RELATED APPLICATIONS

This application is a non-provisional application from and claims priority to U.S. Provisional Patent Application No. 63/649,727 entitled “SYSTEMS AND METHOD FOR PROVIDING A COLLABORATIVE MAP FOR AN AIRCRAFT” and filed on May 20, 2024, the entire disclosure of which is incorporated by reference herein.

### TECHNICAL FIELD

The disclosure herein relates to a system of an aircraft during a taxi phase or in flight. In particular, the disclosure herein relates to a system for providing a collaborative map module, a module allowing direct communication between the aircraft, the Air Traffic Control (ATC), and the Operations Control Center (OCC) of an airline, and a ground and in-flight trajectory assistant module.

### BACKGROUND

During taxi-in, taxi-out, and in-flight, when all systems are functioning properly, the workload of pilots is considered acceptable and the risk of human error due to distraction or overwork is low. Nevertheless, any additional event that occurs increases the likelihood of such human error because the pilots during these phases need to spend time on the additional event, rather than the normal operating procedures during flight or taxiing the aircraft. Today's systems help to reduce pilot workload and remove the risk of human error during taxi-in, taxi-out, and in-flight phases of a commercial flight. However, it would be desirable to have a complete tool efficient enough to further reduce the pilot workload and accelerate exchanges between ground structures and aircraft.

### SUMMARY

As such, there is a need for an improved system that addresses some of the above needs during an in-flight or taxiing phase for an aircraft.

A communication system is disclosed comprising: one or more processing circuits coupled to a memory having executable instructions stored thereon, where, in response to executing the instructions, the one or more processing circuits are configured to: generate a collaborative map on a first user interface of a first computing device within a cockpit of an aircraft for a pilot to view and interact with, the collaborative map including a plurality of digital layers that each display a different interface view to the pilot; generate a digital assistant on a second user interface of a second computing device within the cockpit of the aircraft for the pilot to view and interact with, the digital assistant to optimize missions of the aircraft on ground and in flight; manage communication of data between the collaborative map and a corresponding second collaborative map managed by a third computing device; and manage communication of data between the digital assistant and a corresponding second digital assistant managed by a fourth computing device.

An aircraft communication method is disclosed comprising: generating, by a processing circuit, a collaborative map on a first user interface of a first computing device within a cockpit of an aircraft for a pilot to view and interact with, the collaborative map including a plurality of digital layers that each display a different interface view to the pilot; generating, by the processing circuit, a digital assistant on a second user interface of a second computing device within the cockpit of the aircraft for the pilot to view and interact with, the digital assistant to optimize missions of the aircraft on ground and in flight; managing, by the processing circuit, communication of data between the collaborative map and a corresponding second collaborative map managed by a third computing device; and managing communication of data between the digital assistant and a corresponding second digital assistant managed by a fourth computing device.

### BRIEF DESCRIPTION OF THE DRAWINGS

By way of example, specific embodiments of the disclosed methods and devices will now be described, with reference to the accompanying drawings, in which:

FIG. 1 illustrates a communication environment in accordance with one embodiment.

FIG. 2A is a block diagram illustrating an example communication system in accordance with one embodiment.

FIG. 2B is a block diagram illustrating an example collaborative map in accordance with one embodiment.

FIG. 2C is a block diagram illustrating an example digital assistant in accordance with one embodiment.

FIG. 3 illustrates a communications network in accordance with one embodiment.

FIG. 4 is a flow chart of an example method in accordance with one embodiment.

FIG. 5 is a flow chart of another example method in accordance with another embodiment.

FIG. 6 is a block diagram of an example computer-readable storage medium in accordance with one embodiment.

FIG. 7 is a block diagram of an example computing system in accordance with another embodiment.

It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be further understood that this disclosure is not limited to the particular embodiments illustrated herein. In the drawings, like numbers refer to like elements throughout unless otherwise noted.

### DETAILED DESCRIPTION

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities.

Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are configured to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Embodiments of the present disclosure will now be described more fully hereinafter with reference to the accompanying drawings, in which several exemplary embodiments are shown. The subject matter of the present disclosure, however, may be embodied in many different forms and types of methods and devices aircraft taxiing and in-flight systems, and should not be construed as limited to the embodiments set forth herein. Rather, these embodiments are provided so that this disclosure will be thorough and complete, and willfully convey the scope of the subject matter to those skilled in the art. In the drawings, like numbers refer to like elements throughout.

The systems and techniques described herein provide an improvement over current technology by providing a synchronized system that implements direct communication between the pilot in the aircraft and the Air Traffic Control (ATC) and the Operations Control Center (OCC) of an airline with which the aircraft is associated. Additionally, the systems described herein improve the communication technology between pilots, ATC, and the OCC because they provide a structure to support the collaborative map described herein, gathering and updating multiple sources of geo-referenced data, enhance situational awareness of the pilots, ATC, and OCC, and optimizes clearance management and support for weather avoidance.

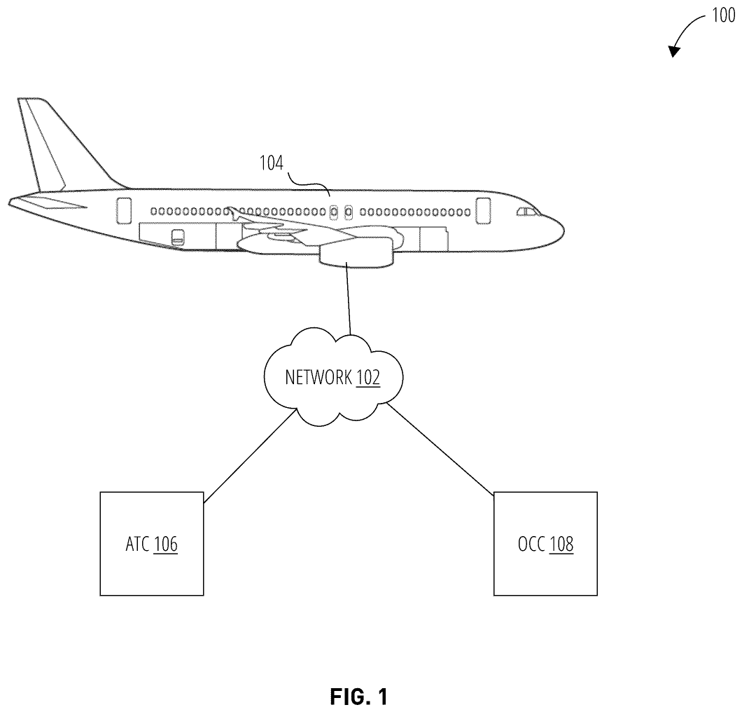

FIG. 1 is a block diagram illustrating an example communication environment 100. The communication environment 100 includes a network 102 connecting computing devices onboard an aircraft 104 with computing devices associated with Air Traffic Control (ATC) 106 at an airport, and the Operations Control Center (OCC) 108 of an airline with which the aircraft 104 is associated.

In some embodiments, the network 102 can be any suitable network to allow ATC 106 and OCC 108 to communicate with computing devices onboard the aircraft 104 whether on the ground or in the air. For example, in some embodiments, the network is a mobile communications network such as 3G, long term evolution (LTE), 4G, 5G, 6G, or any other suitable mobile communications network. The network 102 can further include a satellite-based communications network or a wired network (e.g., for when the aircraft 104 is on the ground and refueling or preparing for takeoff). In some embodiments the network 102 can include a wireless fidelity (Wi-Fi) network or wireless local area network (WLAN), for example, when the aircraft 104 is on the ground and is in close proximity to a wireless access point (WAP).

The aircraft 104 comprises avionics equipment, which provides computing ability to the aircraft 104. The aircraft's avionics equipment includes a position-awareness equipment enabling the avionics to know in real-time the geographical position of the aircraft 104, such as a GNSS (Global Navigation Satellite System) receiver, for example a GPS (Global Positioning System) receiver, a GLONASS receiver, a Galileo receiver, or any other suitable device now known or later discovered.

In some embodiments, the computing devices described above, which the aircraft 104, ATC 106, and OCC 108 use to communicate with each other can include one or more servers located on or at each of the aircraft 104, the ATC 106, and the OCC 108. The servers are configured to communicate with each other over the network 102 using known protocols such as transport control protocol (TCP), user datagram protocol (UDP), Internet protocol (IP), or any other suitable method.

In some embodiments, each of the servers communicate with each other to maintain one or more applications. In some embodiments, the one or more applications include a collaborative map, a digital assistant, or any other suitable application. The applications are implemented, operated, and/or maintained using the servers and graphic user interfaces (GUIs) associated with the applications are displayed on computing devices (e.g., tablets). These computing devices are described in more detail below.

In some embodiments, the one or more servers also maintain one or more databases for collecting, receiving, and storing data thereon. For example, the aircraft 104 server may maintain a local database to store route data, geographic data, and other data regarding the aircraft 104, its location, or the airport at which it has landed or from which it will take off. Additionally, in some embodiments, the ATC 106 or OCC 108 or some other entity may maintain a ground database to maintain data regarding the airport, airline information, arrival and departure schedules, weather data, and other information.

The systems and methods described herein that operate within the communication environment 100 correspond to a collaborative solution to provide better management of aircraft clearances, lower the use to radio transmissions between the pilots of an aircraft and ATC 106 or OCC 108, and accelerate exchanges between communication environment 100 members that support strategic decisions.

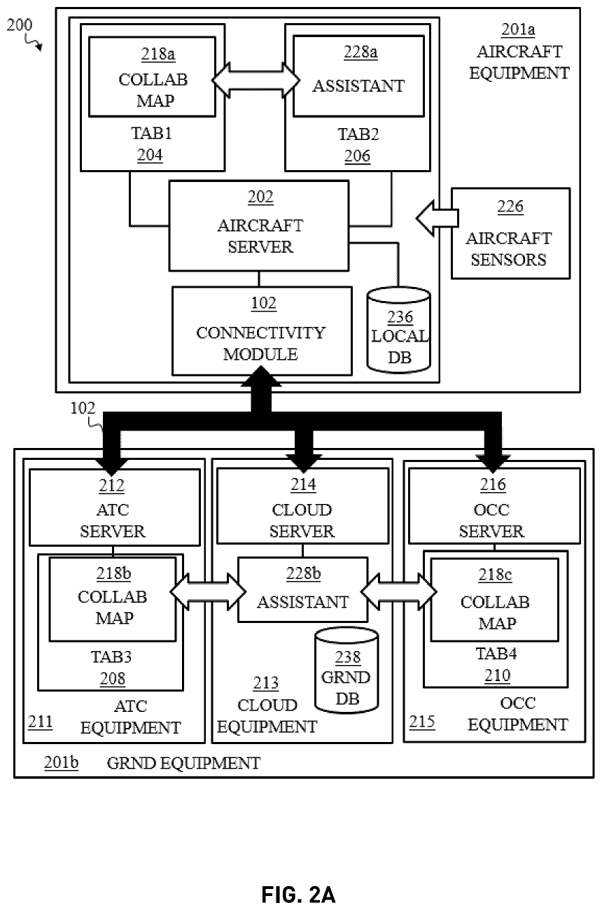

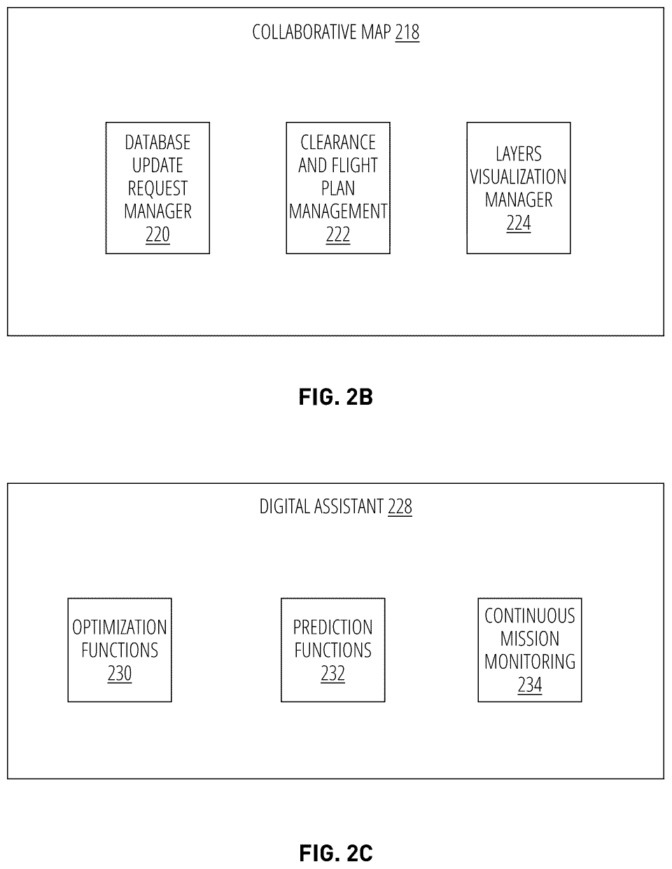

FIG. 2A illustrates a communication system 200 that corresponds to a collaborative solution including a collaborative map module to display aeronautical data and dynamic data of the environment in which the aircraft is operating. In some embodiments, the collaborative map module described herein allows direct communication between the aircraft 104, the ATC 106, and the OCC 108 of the airline associated with the aircraft. Additionally, the embodiments described herein provide a ground as well as an in-flight trajectory assistant module to predict and optimize trajectories for the aircraft, whether in the air or on the ground, taxiing. The example embodiments described herein use server technologies to provide communication, prediction, and optimization services to the pilots of the aircraft, ATC 106, and OCC 108. A local aircraft server 202 onboard the aircraft is also used in case of lost connectivity to the ground communication devices described herein. The embodiments described herein provide direct communication between the aircraft 104, the ATC, and the OCC of the airline associated with the aircraft 104.

The communication system 200 illustrated in FIG. 2A is logically described with reference to systems and devices onboard the aircraft 104 and systems and devices on the ground, for example ATC and OCC, as well as a cloud-based system that can be located at any suitable location on the ground (e.g., at the OCC, at ATC, or any other suitable location with an Internet connection that allows communication between the cloud-based system and the ATC, OCC, and aircraft systems).

In some embodiments, the communication system 200 includes aircraft equipment 201a, which includes an aircraft server 202 onboard the aircraft 104. The aircraft server 202 may be part of the avionics of the aircraft 104. The communication system 200 further includes at least one on-ground server. In some embodiments, the at least one on-ground server includes an ATC server 212 operated by an operator of the ATC 106 for ATC-related operations. In some embodiments, the at least one on-ground server includes an OCC server 216 operated by an operator of the OCC 108. In some embodiments, the at least one on-ground server further includes a cloud server 214. The cloud server 214 can be located at any suitable location on the ground (e.g., at OCC premises, at ATC premises, or any other suitable location with connection, such as an Internet connection, that allows communication between the cloud server 214 and any other on-ground server, such as the ATC server 212 and/or the OCC server 216.

In some embodiments, aircraft equipment 201a includes aircraft equipment HMI (Human-Machine Interface) enabling devices, such as displays, for example part of a Cockpit Display System (CDS), or touch screens or tablets, thus enabling interactions with the pilot(s) of the aircraft 104.

In some embodiments, the communication system 200 includes one or more processing circuits coupled to a memory having executable instructions stored thereon. For example, the one or more processing circuits may refer to processing circuits onboard the aircraft server 202, the ATC server 212, or the OCC server 216. Onboard the aircraft 104 (e.g., in the cockpit), a first aircraft tablet 204 and a second aircraft tablet 206 are provided to display various data and receive data from the pilots. In some embodiments, the first aircraft tablet 204 and the second aircraft tablet 206 may each include a mobile device such as a tablet computer, mobile phone, smart phone, personal data assistant, iPad, or any other suitable mobile device or tablet-like computing device, such as an EFB (Electronic Flight Bag) device.

The first aircraft tablet 204 and the second aircraft table 206 are configured to display a graphical user interface (GUI) for one or both of the collaborative map 218a and the digital assistant 228a described herein. For example, the first aircraft tablet 204 may display a GUI for the collaborative map 218a and the second aircraft tablet 206 may display the GUI for the digital assistant 228a. Each of the first aircraft tablet 204 and the second aircraft tablet 206 are controlled by respective processing circuits on each tablet. As such, when referring to one or more processing circuits, the present disclosure may be referring to processing circuits operating on the first aircraft tablet 204 or the second aircraft tablet 206.

In some embodiments, the collaborative map 218a and the digital assistant 228a are applications (e.g., mobile applications) downloaded on a corresponding tablet. That is, the first aircraft tablet 204 in the cockpit includes an application corresponding to the collaborative map 218a and the second aircraft tablet 206 in the cockpit includes a second application corresponding to the digital assistant 228. The applications downloaded onto the tablets are configured to display data on a screen of the tablets and receive data and inputs from a pilot or other user of the tablets. The tablets, including first aircraft tablet 204 and second aircraft tablet 206, are configured to receive data from the aircraft server 202 to display on their respective screens and also send data from inputs from the users to the aircraft server 202. The aircraft server 202 is then configured to share this data and various communications with the ATC server 212, cloud server 214, and OCC server 216 on the ground via a connectivity module of the network 102.

The aircraft server 202 may also receive data from the ATC server 212 and the OCC server 216 or the cloud server 214 to display data or display communications to the collaborative map 218a or digital assistant 228a on the tablets onboard the aircraft 104. As such, the present disclosure may also refer to one or more processing circuits performing operations associated with the aircraft server 202, ATC server 212, or OCC server 216. In any event, the processors of the aircraft server 202, first aircraft tablet 204, second aircraft tablet 206, ATC server 212, OCC server 216, cloud server 214, an ATC tablet 208, and an OCC tablet 210 are all in communication with each other via network 102 and may be referred to as one or more processors or processing circuits to cause various data to be displayed on, received by, or sent to the collaborative map 218a or the digital assistant 228.

In some embodiments, the one or more processing circuits of the tablets, and the aircraft server 202 are configured to generate a collaborative map 218a on a first user interface of first aircraft tablet 204 within a cockpit of an aircraft for a pilot to view and interact with, the collaborative map 218a including a plurality of digital layers that each display a different interface view to the pilot.

As shown at FIG. 2B, in some embodiments, the collaborative map 218a is displayed on a user interface of the first aircraft tablet 204 and includes a database update request manager 220, clearance and flight plan management 222, and layers visualization manager 224.

The layers visualization manager 224 is configured for visualizing a plurality of different layers or windows on the tablet. More specifically, the collaborative map 218a includes a plurality of layers for the pilot to view and interact with, each of the plurality of layers illustrating a discrete set of images or data. The layers may be visualized as one or more pages or one or more windows that each depict a different aspect of the aircraft 104, the weather, a flight trajectory of the aircraft, or any other function described herein. For example, in some embodiments, the different layers displayed on the layers visualization manager 224 of the first aircraft tablet 204 includes one or more of: a visual display of the aircraft; a static aeronautical layer with airport ways, clearance points, and a digital terrain model; a layer displaying dynamic aeronautical data including weather data, 3-dimensional maps, traffic in-flight and on ground, and NOTAM data; a trajectory layer with aircraft trajectories in-flight and on-ground; a layer displaying dialog windows depicting present communication data between the pilots, air traffic control (ATC), and the OCC of the airline; a layer displaying proposal data to manage communications between the pilots, ATC, and the OCC; a feedback layer displaying feedback data and information from the pilots to the ATC, and the OCC; a communication layer connected with the digital assistant, the communication layer to display optimizations, predictions, and monitoring of the digital assistant; and a performance layer depicting uses on ground servers and aircraft local servers to provide the collaborative map.

Referring back to FIG. 2A, in some embodiments, the second aircraft tablet 206 and the aircraft server 202 are configured to generate a digital assistant 228a on the second aircraft tablet 206 within the aircraft for the pilot (e.g., or other user) to view and interact with, the digital assistant 228a being configured to optimize missions of the aircraft on the ground and in flight. For example, the digital assistant 228a is further configured to compute flight predictions and provide outputs to the pilots to allow a continuous monitoring of tasks that allow optimization of missions of the aircraft taxiing on the ground and in flight. In some embodiments, the digital assistant 228a is maintained between the second aircraft tablet 206, the aircraft server 202, and a cloud server 214 located on the ground. Predictions and other functions are performed on the cloud server 214 for the corresponding second digital assistant 228b and then forwarded to the aircraft server 202 to display on the second aircraft tablet 206. Then, as the pilot interacts with the digital assistant 228a on the second aircraft tablet 206, the interactions and inputs from the pilot are sent to the aircraft server 202 and forwarded to the cloud server 214 for synchronization.

In some embodiments, the digital assistant 228a is further configured to create a flight plan route for the aircraft. The digital assistant 228a may further create a digital folder with identification of NOTAM/weather information relevant to the flight plan, extract weather and NOTAM information from the digital folder as well as documentation data, and generate a performance forecast based on the weather and NOTAM information and the documentation data. In some embodiments, the digital assistant 228a is configured to predict a takeoff time, taxi time, and flight time based on the flight plan and the weather and NOTAM information and the documentation data, predict a trajectory of the aircraft based on the extracted data and the predicted takeoff time, taxi time, and flight time, and modify the trajectory in real time depending on a weather event during the flight and other external events. These predictions and calculations are performed by a combination of the second aircraft tablet 206 and the cloud server 214, but most of the more complicated calculations are performed with the cloud server 214 and then shared with the aircraft server 202 and sent to the second aircraft tablet 206 for display on the GUI thereof.

In some embodiments, the digital assistant 228a onboard the aircraft 104 will perform optimization and monitoring of trajectory predictions, and takeoff time, taxi time, and flight time predictions, made by the corresponding second digital assistant 228b associated with the cloud server 214. On the other hand, the corresponding second digital assistant 228b associated with the cloud server 214 will focus more on predictions and generating the trajectories, and then consider optimizations and monitoring based on any optimizations and monitoring proposed by the digital assistant 228a onboard the aircraft 104.

As described herein, the aircraft 104 may further include an aircraft database 236 onboard. The aircraft database 236 can include various data stored thereon including route data, weather data, passenger and flight crew data, and any other suitable data that may be useful to the collaborative map 218 or the digital assistant 228. For example, the aircraft database 236 can include visualization data that allows the collaborative map 218 to display a visualization of the aircraft on the first aircraft tablet 204. In some embodiments, the collaborative map 218 includes a database update request 220 function that allows the pilots to select and update data in the aircraft database 236. In some embodiments, the aircraft database 236 is in communication with the aircraft server 202, and the aircraft server 202 is configured to extract data from the aircraft database 236 to make predictions and provide data to the collaborative map 218a and the digital assistant 228a onboard the aircraft 104.

In some embodiments, the collaborative map 218 further includes a clearance and flight plan management 222 function. This function allows the collaborative map 218 to display ATC clearance messages on the collaborative map 218 regarding the aircraft being cleared for taking off, landing, or entering the runway. The clearance and flight plan management 222 function also allows the pilot to manage and edit the flight plan for the aircraft as needed (e.g., in an adverse weather event or airport or runway closure at the destination airport).

As shown at FIG. 2C, in some embodiments, the digital assistant 228 includes optimization functions 230 that allow the digital assistant 228 to optimize the flight plan or to optimize taxiing to and from the runway. The digital assistant 228 may further include prediction functions 232 which allows the digital assistant 228 to make predictions regarding the takeoff time, taxi time, and flight time of the aircraft 104 based on the flight plan and the weather and NOTAM information and the documentation data. The prediction functions 232 also allow the digital assistant 228 to predict a trajectory of the aircraft based on the extracted data and the predicted takeoff time, taxi time, and flight time, and modify the trajectory in real time depending on a weather event during the flight and other external events.

Finally, in some embodiments, the digital assistant 228 further includes a continuous mission monitoring 234 function that allows the digital assistant 228 to continuously monitor the flight path and status of the aircraft. This function provides additional help to the optimization functions 230 and provides data thereto to help generate the optimizations.

As described above, FIG. 2A also depicts the corresponding devices of the communication system 200 that operate on the ground, referred to as ground equipment 201b, and communicate with the collaborative map 218a and digital assistant 228a in the cockpit of the aircraft 104. For example, on the ground, there is ATC equipment 211 that includes the ATC server 212, a third tablet 208 implementing a corresponding second collaborative map 218b associated with the ATC 106. Additionally, there is cloud equipment 213 as well that includes the cloud server 214, the corresponding second digital assistant 228b, and a ground database 238. Finally, there is OCC equipment 215 that includes the OCC server 216, and a fourth tablet 210 implementing a corresponding third collaborative map 218c associated with the OCC 108 of the airline associated with the aircraft 104. That is, ATC 106 at the airport has its own instance of the collaborative map 218 and the OCC 108 for each airline has an instance of the collaborative map 218 for their aircraft. In addition to the instances of the collaborative map 218, there is also an instance of the digital assistant 228 on a cloud server 214. That is the ground instance of the digital assistant 228 is maintained in the cloud server 214 and communicates with the other servers via network 102.

In some embodiments, the collaborative map 218a is further configured to provide tools to manage communication between the collaborative map 218a and the corresponding second collaborative map collaborative map 218b managed by the ATC server 212. The collaborative map 218a associated with the aircraft 104 is configured to provide and maintain a secure communication channel between the collaborative map 218a and the corresponding second collaborative map 218b associated with the ATC that is maintained by the ATC server 212. The collaborative map 218a on the aircraft 104 and the corresponding second collaborative map 218b associated with the ATC server 212 are configured to generate interfaces to accelerate a clearance process with text-based enablers for the pilots to select and generate interfaces to propose a new flight plan data during an approach phase of the aircraft 104. In some embodiments, the corresponding second collaborative map managed by the ATC server 212 is configured to generate interfaces to accept the new flight plan data from the collaborative map 218a associated with the aircraft 104.

In some embodiments, the communication system 200 is configured to manage communication of data between the collaborative map 218a onboard the aircraft 104 and at the ATC and OCC and manage communication of data between the digital assistant 228a onboard the aircraft 104 and in the cloud server 214. Each of the aircraft server 202, ATC server 212, and OCC server 216 communicate with each other to manage and synchronize data, flight paths, clearances and other features so that each instance of the collaborative map 218a displays the correct data and flight paths.

As shown in FIG. 2A, the collaborative map 218 instances on the ground (e.g., associated with ATC and OCC) each also have the database update request 220, clearance and flight plan management 222, and layers visualization 224 functions described above. Again, these functions are synchronized by communication between the aircraft server 202, ATC server 212, and OCC server 216. For example, if the ATC provides a clearance indication on the collaborative map 218, this clearance indication is sent in a message from the ATC server 212 to the OCC server 216 and the aircraft server 202 so that those servers can update their respective collaborative map 218 to also display the clearance indicator.

In some embodiments, the communication system 200 is configured to receive, display, and/or analyze data from a network of the airline associated with the aircraft, systems onboard the aircraft, and data suppliers associated with the airline. In some embodiments, the communication system 200 is configured to display the data discussed above on the collaborative map 218a, the digital assistant 228, the corresponding second collaborative map 218b, the corresponding third collaborative map 218c, or the corresponding second digital assistant 228c. In some embodiments, the data from the network of the airline includes data from the OCC of the airline (e.g., from the OCC server 216), including takeoff time, a ground trajectory, and a flight path or flight trajectory of the aircraft 104. In some embodiments, data captured by systems onboard the aircraft 104 includes data captured by one or more sensors of the aircraft, data from an automatic dependent surveillance-broadcast (ADS-B) system onboard the aircraft, and an ADS-contracts (ADS-C) onboard the aircraft. In some further embodiments, data from data suppliers includes weather data from a weather server, airport data from airport servers, and Notice to Air Men (NOTAM) data.

In some embodiments, the collaborative map 218a associated with the aircraft 104 is further configured to provide tools to manage communication between the collaborative map 218a and the corresponding third collaborative map 218c managed by the OCC server 216. For example, in some embodiments, the collaborative map 218a managed by the aircraft server 202 is configured to provide and maintain a secure communication channel between the collaborative map 218a onboard the aircraft 104 and the corresponding third collaborative map 218c managed by the OCC server 216. In some embodiments, the collaborative map 218a associated with the aircraft 104 is further configured to generate an interface to receive a new flight plan from the corresponding third collaborative map 218c associated with the OCC server 216 and modify an existing one. In some embodiments, the corresponding third collaborative map 218c associated with the OCC server 216 is configured to send a new flight plan proposal to the collaborative map 218a associated with the aircraft server 202 for an approach phase of the aircraft and send a new flight plan proposal to the collaborative map 218a associated with the aircraft server 202 for avoiding a weather hazard or contrail hazard. The corresponding third collaborative map 218c associated with the OCC server 216 may be displayed on and interacted with (e.g., by a user associated with the airline) via OCC tablet 210.

In some embodiments, when connectivity with the network 102 is lost, the aircraft server 202 is configured to solely maintain the collaborative map 218a and the digital assistant 228a with respect to information and data received by the on-board equipment 201a (e.g., inputs from the pilot(s) or from aircraft sensors 226), and to resynchronize with the corresponding second collaborative map 218b and corresponding third collaborative map 218c and the corresponding second digital assistant 228b when connectivity with the network 102 is restored.

In some embodiments, the on-board equipment 201a includes the aircraft sensors 226, such as ADS-B (Automatic Dependent Surveillance-Broadcast) and/or LIDAR (Light Detection And Ranging), or other capture systems used to detect obstacles in proximity of the aircraft 104.

FIG. 2B is a block diagram of the collaborative map 218, in accordance with an example embodiment. In some embodiments, the collaborative map is implemented as a GUI that includes a plurality of digital layers that each display a different or discrete interface view to the pilot(s) or operator(s).

The collaborative map 218 includes a database update request manager 220, a clearance and flight plan manager 222, and a layers-visualization manager 224.

The database update request manager 220 is configured to allow the pilot(s) or operator(s) to select and update data respectively in the aircraft database 236 or in the ground database 238. Data contained in the aircraft database 236 and in the ground database 238 may be synchronized. Some data contained in the aircraft database 236 and in the ground database 238 may be synchronized automatically, and some data contained in the aircraft database 236 and in the ground database 238 may be synchronized on-demand (manually).

The clearance and flight plan manager 222 is configured to enter and display clearance messages from ATC operator(s) regarding the aircraft being cleared for taking off, landing, or entering a runway. The clearance and flight plan manager 222 may further be configured to allow the pilot(s) to send clearance requests to ATC operator(s) regarding the aircraft being cleared for taking off, landing, or entering a runway. The clearance and flight plan manager 222 is configured to generate interfaces to accelerate clearance process with text-based enablers for the pilot(s) to select.

The clearance and flight plan manager 222 is also configured to allow the pilot(s) to manage and edit flight plans for the aircraft 104 as needed (e.g., in an adverse weather event or airport or runway closure at a destination airport).

In some embodiments, the collaborative map 218a is displayed on a GUI of the first aircraft tablet 204 and at least the corresponding second collaborative map 218b or the corresponding third collaborative map 218c is displayed on a GUI of on-ground equipment. In some embodiments, the corresponding second collaborative map 218b is displayed on a GUI of the ATC equipment 211 and the corresponding second collaborative map 218b is displayed on a GUI of the OCC equipment 215.

The layers-visualization manager 224 is configured to visualize a plurality of different layers or windows on screen. More specifically, the GUI of the collaborative map 218 includes a plurality of layers for the pilot(s) or operator(s) to view and interact with, each of the plurality of layers illustrating a discrete set of images or data. The layers may be visualized as one or more pages or one or more windows which each depict a different aspect of the aircraft 104, the weather, a flight or ground trajectory of the aircraft 104, or any other function described herein. For example, in some embodiments, the different layers displayed on the GUI of the collaborative map 218 by the layers-visualization manager 224 includes several layers among: a visual display of the aircraft 104; a static aeronautical layer with airport ways, clearance points, and a digital terrain model; a dynamic aeronautical layer displaying dynamic aeronautical data including weather data, 3-dimensional maps, traffic in-flight and on ground; a message layer for NOTAM (Notice to Airmen) information; a trajectory layer with aircraft trajectories inflight and on-ground; a dialog layer displaying a dialog windows depicting present communication data between the pilots, ATC 106, and the OCC 108; a layer displaying proposal data to manage communications between the pilots, ATC 106 and OCC 108; a feedback layer displaying feedback data and information from the pilot(s) to ATC 106 and OCC 108; a communication layer connected with the digital assistant 228 to display optimizations, predictions, and monitoring performed by the digital assistant 228; and a performance layer depicting uses of on-ground server resources and on-board server resources to provide the collaborative map 218.

FIG. 2B is a block diagram illustrating the digital assistant 228, in accordance with an example embodiment. The digital assistant 228 is configured to optimize missions of the aircraft 104 on the ground (taxiing) and in flight, to compute flight predictions and to provide outputs to the pilot(s) to allow a continuous monitoring of tasks that allow optimization of missions of the aircraft 104 taxiing on the ground and in flight. To do so, the digital assistant 228 includes optimization functions 230, prediction functions 232 and continuous mission monitoring 234.

The optimization functions 230 allow the digital assistant 228 to optimize a flight plan and/or to optimize on-ground taxi phase, typically in view of detected obstacles.

The prediction functions 232 allow the digital assistant 228 to make predictions regarding takeoff time, taxi time, and flight time of the aircraft 104, based on the flight plan and weather and NOTAM information and potentially other documentation data. The prediction functions 232 also allow the digital assistant 228 to predict a trajectory of the aircraft 104 based on the extracted data and the predicted takeoff time, taxi time, and flight time, and modify the trajectory in real-time depending on weather events during the flight as well as on potential other external events.

In some embodiments, the prediction functions 232 allow modifying the trajectory of the aircraft according to obstacles detected with respect to a current trajectory of the aircraft 104, such as weather obstacles in flight or airport's traffic when taxiing on the ground. Such obstacles are for example detected using the aircraft sensors 226 or NOTAM information.

The continuous mission monitoring 234 allows the digital assistant 228 to continuously monitor the trajectory and status of the aircraft 104. It provides additional help to the optimization functions 230 and provides data thereto to help generate optimizations of the flight plan and/or of the on-ground taxi phase.

In some embodiments, the digital assistant 228 is configured to create a flight plan route for the aircraft 104. The digital assistant 228 may further create a digital folder with identification of weather and NOTAM information relevant to the flight plan, extract weather and NOTAM information from the digital folder as well as potentially other documentation data, and generate a performance forecast based on the weather and NOTAM information and the documentation data.

In some embodiments, the digital assistant 228 is configured to predict a takeoff time, taxi time, and flight time based on the flight plan and the weather and NOTAM information and the documentation data. The digital assistant 228 is configured to predict a trajectory of the aircraft 104 based on the extracted data and the predicted takeoff time, taxi time, and flight time, and modify the trajectory in real-time depending on a weather event during the flight and other external events.

In some embodiments, the predictions and related calculations are performed by a combination of the aircraft equipment 201a and the ground equipment 201b. For example, most of the more complicated calculations are performed with the cloud server 214 with respect to the corresponding second digital assistant 228b and then shared with the aircraft server 202 for update of the digital assistant 228a, with GUI information thereof being then sent to the second aircraft tablet 206 for display to the pilot(s).

In some embodiments, the digital assistant 228a onboard the aircraft 104 performs optimization and monitoring of trajectory predictions, and takeoff time, taxi time, and flight time predictions, made by the corresponding second digital assistant 228b on the ground. Then, as the operator(s) interacts with the corresponding second digital assistant 228b on the ground, the interactions and inputs from the operator(s) are sent from the cloud server 214 to the aircraft server 202 for synchronization. On the other hand, the corresponding second digital assistant 228b on the ground focuses more on predictions and generating the trajectories, and then consider optimizations and monitoring based on any optimizations and monitoring proposed by the digital assistant 228a onboard the aircraft 104. Thus, as the pilot(s) interacts with the digital assistant 228a onboard the aircraft 104 (e.g., using the second aircraft tablet 206), the interactions and inputs from the pilot(s) are sent from the aircraft server 202 to the cloud server 214 for synchronization.

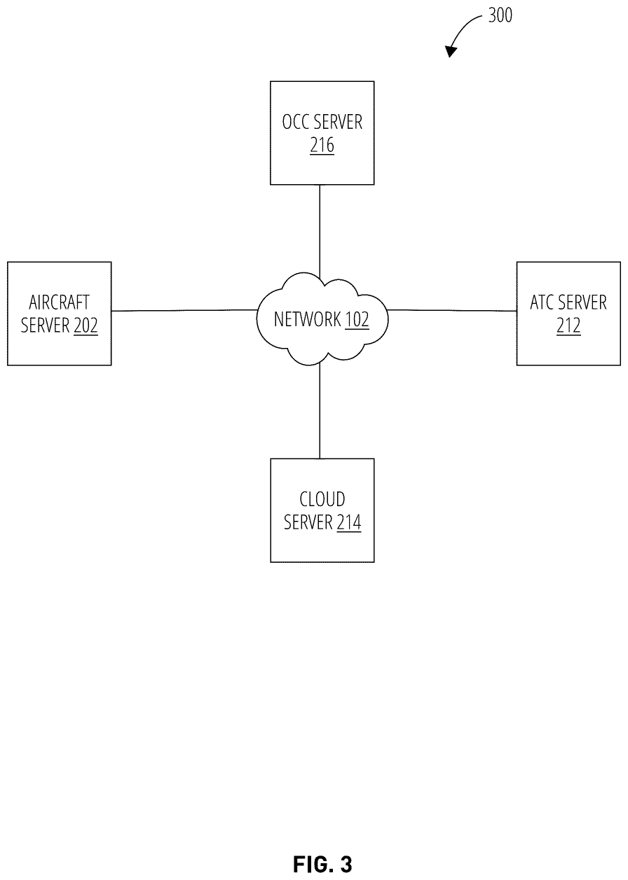

FIG. 3 illustrates an example communication scenario 300 in accordance with some embodiments of the present disclosure. The communication scenario 300 includes a taxi trajectory management scenario whereby ATC instructions are provided to the aircraft and pilots for taxiing the aircraft before the aircraft leaves the gate. The communication scenario 300 includes a series of communication steps between the aircraft server 202, ATC server 212, and OCC server 216 described above with respect to FIG. 2. First, the ATC determines that the aircraft is cleared for taxiing to the runway. Following the clearance determination, the ATC server 212 generates a clearance message and sends the clearance message to the OCC server 216. The OCC server 216 receives the clearance message for the particular aircraft to begin taxiing.

In some embodiments, the OCC server 216 then calculates an on-ground trajectory of the aircraft for taxiing to the runway and this trajectory is optimized by the OCC server 216 based on airport data, including data on other aircraft and their departure times. The OCC server 216 also optimizes the on-ground trajectory based on weather data and other data regarding the environment of the airport. Once the on-ground trajectory is selected and optimized, the OCC server 216 transmits the taxiing trajectory to the aircraft server 202. The digital assistant, estimates or computes the takeoff time, taxi time, and flight time based on the various factors discussed above, and transmits these times to the OCC server 216, which forwards those times to the aircraft server 202.

Upon receiving the computed takeoff time, taxi time, and flight time as well as the optimized taxiing trajectory, the aircraft server 202 causes the received data to be displayed on the aircraft tablet in the collaborative map described above in FIG. 2.

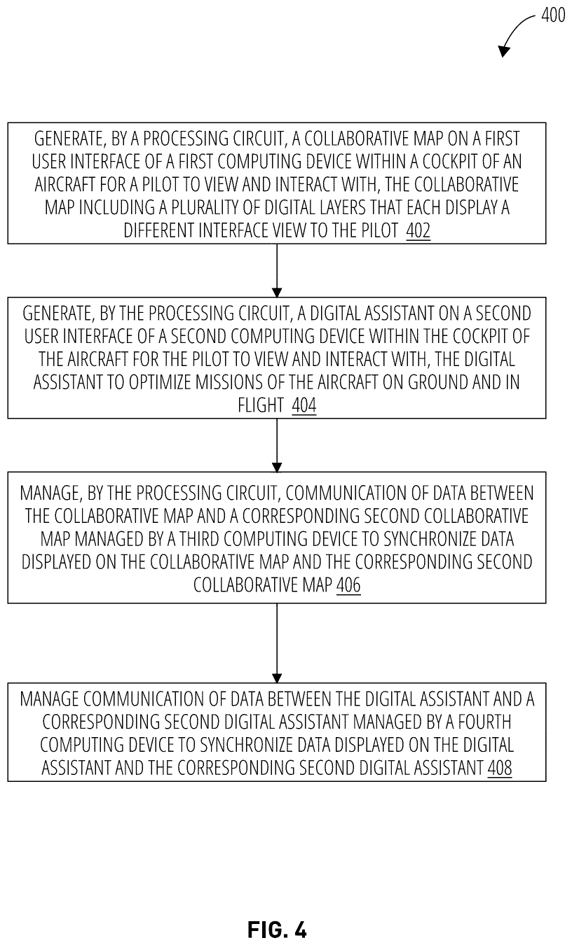

FIG. 4 is a flow chart depicting operations of an aircraft communication method 400 in accordance with some embodiments of the present disclosure. As shown at block 402, the method 400 includes generating, by a processing circuit, a collaborative map on a first user interface of a first computing device within a cockpit of an aircraft for a pilot to view and interact with, the collaborative map including a plurality of digital layers that each display a different interface view to the pilot. As shown at block 404, the method 400 includes generating, by the processing circuit, a digital assistant on a second user interface of a second computing device within the cockpit of the aircraft for the pilot to view and interact with, the digital assistant to optimize missions of the aircraft on ground and in flight.

As shown at block 406, the method 400 includes managing, by the processing circuit, communication of data between the collaborative map and a corresponding second collaborative map managed by a third computing device to synchronize data displayed on the collaborative map and the corresponding second collaborative map. As shown at block 408, the method 400 includes managing communication of data between the digital assistant and a corresponding second digital assistant managed by a fourth computing device to synchronize data displayed on the digital assistant and the corresponding second digital assistant.

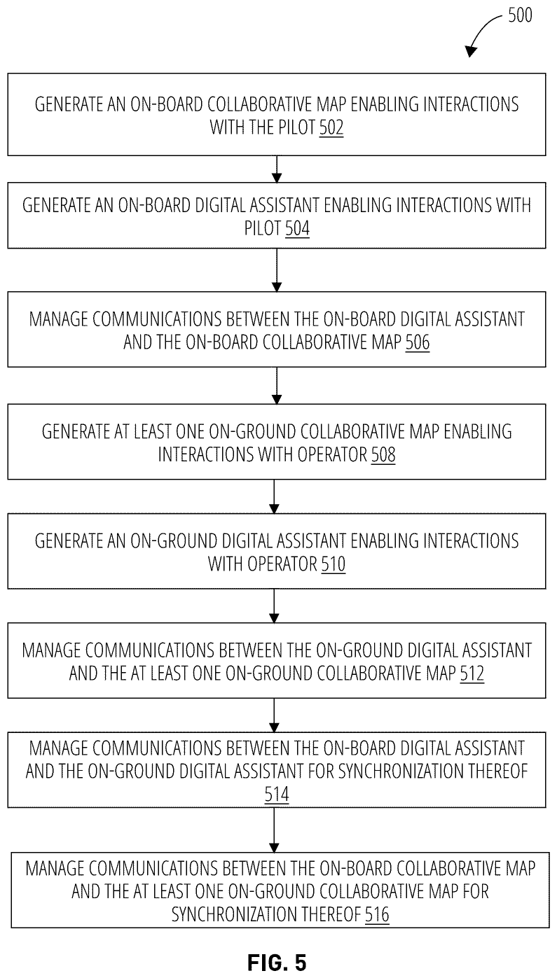

FIG. 5 is a flow chart depicting operations of a second method 500 in accordance with some embodiments of the present disclosure. At block 502, the aircraft equipment 201a (typically by processing circuits thereof) generates an on-board collaborative map enabling interactions with the pilot(s). More particularly, the aircraft equipment 201a generates the collaborative map 218a.

At block 504, the aircraft equipment 201a (typically by processing circuits thereof) generates an on-board digital assistant enabling interactions with the pilot(s). More particularly, the aircraft equipment 201a generates the digital assistant 228a.

At block 506, in an embodiment, the aircraft equipment 201a (typically by processing circuits thereof) manages communications between the on-board digital assistant and the on-board collaborative map. More particularly, the aircraft equipment 201a manages communications between the digital assistant 228a and the collaborative map 218a.

At block 508, the ground equipment 201b (typically by processing circuits thereof) generates at least one on-ground collaborative map enabling interactions with the operator(s). More particularly, the ground equipment 201b generates at least one instance (e.g., corresponding second collaborative map 218b or corresponding third collaborative map 218c) of the collaborative map 218. In a particular embodiment, the ground equipment 201b generates the corresponding second collaborative map 218b at the ATC equipment 211 and generates the corresponding third collaborative map 218c at the OCC equipment 215.

At block 510, the ground equipment 201b (typically by processing circuits thereof) generates an on-ground digital assistant enabling interactions with the operator(s). More particularly, the ground equipment 201b generates the corresponding second digital assistant 228b. In a particular embodiment, the ground equipment 201b generates the corresponding second digital assistant 228b at the cloud server 214. Interactions with operators are then operated through the ATC equipment 211 and/or the OCC equipment 215.

At block 512, the ground equipment 201b (typically by processing circuits thereof) manages communications between the on-ground digital assistant and the at least one on-ground collaborative map for interactions thereof, e.g., for the at least one on-ground collaborative map to request optimizations and/or predictions to the on-ground digital assistant. More particularly, the ground equipment 201b manages communications between the corresponding second digital assistant 228b and the corresponding second collaborative map 218b, and the corresponding third collaborative map 218c for interactions thereof. These communications may be performed via a secure communication channel provided and maintained by the collaborative map between the collaborative map and the corresponding second collaborative map 218b and/or the corresponding third collaborative map 218c.

In some embodiments, when several instances of the on-ground collaborative map exist, the ground equipment 201b (typically by processing circuits thereof) manages communications between the several instances of the on-ground collaborative map for synchronization thereof. These communications may be performed via a secure communication channel.

At block 514, the aircraft equipment 201a and the ground equipment 201b (typically by processing circuits thereof) cooperate to manage communications between the on-board digital assistant and the on-ground digital assistant for synchronization thereof. More particularly, the aircraft equipment 201a and the ground equipment 201b cooperate to manage communications between the digital assistant 228a (on-board) and the corresponding second digital assistant 228b (on-ground, e.g., at the cloud server 214) for synchronization thereof. These communications may be performed via a secure communication channel.

At block 516, the aircraft equipment 201a and the ground equipment 201b (typically by processing circuits thereof) cooperate to manage communications between the on-board collaborative map and the at least one on-ground collaborative map for synchronization thereof. More particularly, the aircraft equipment 201a and the ground equipment 201b cooperate to manage communications between the collaborative map 218a (on-board) and the corresponding second collaborative map 218b and corresponding third collaborative map 218c (on-ground) for synchronization thereof. These communications may be performed via a secure communication channel.

According to an example, the collaborative map 218a (at the aircraft 104) is configured to generate an interface to receive a clearance indications from the corresponding second collaborative map 218b (at the ATC 106) and to display the received clearance indications. The corresponding second collaborative map 218b (at the ATC 106) is configured to generate and send clearance indications to the collaborative map 218a (at the aircraft 104) for entering a runway or for initiating taxi phase. The corresponding third collaborative map 218c (at the OCC 108) is synchronously modified in accordance.

According to another example, the collaborative map 218a (at the aircraft 104) is configured to generate an interface to receive a new flight plan from the corresponding third collaborative map 218c (at the OCC 108) and modify an existing flight plan. The corresponding third collaborative map 218c (at the OCC 108) is configured to generate and send a new flight plan proposal to the collaborative map 218a (at the aircraft 104) for an approach phase of the aircraft and/or to send a new flight plan proposal to the instance 218a of collaborative map 218 (at the aircraft 104) for avoiding a weather hazard or contrail hazard. The corresponding second collaborative map 218b (at the ATC 106) is synchronously modified in accordance.

According to yet another example, the corresponding second collaborative map 218b (at the ATC 106) determines that the aircraft is cleared for taxiing to a take-off runway. Following the clearance determination, the corresponding second collaborative map 218b (at the ATC 106) generates a clearance message and sends the clearance message to the corresponding third collaborative map 218c (at the OCC 108). The corresponding third collaborative map 218c (at the OCC 108) then receives the clearance message for the particular aircraft to begin taxiing. The corresponding third collaborative map 218c (at the OCC 108) then calculates an on-ground trajectory of the aircraft for taxiing to the runway and this trajectory is optimized by the corresponding third collaborative map 218c (at the OCC 108) based on airport data, including data on other aircraft and their departure times. The corresponding third collaborative map 218c (at the OCC 108) also optimizes the on-ground trajectory based on weather data and other data regarding the environment of the airport. Once the on-ground trajectory is selected and optimized, the corresponding third collaborative map 218c (at the OCC 108) transmits the taxiing trajectory to the collaborative map 218a (on-board) and to the corresponding second collaborative map 218b (at the ATC 106) for synchronization and further display. Moreover, the corresponding third collaborative map 218c (at the OCC 108) transmits the taxiing trajectory to the corresponding second digital assistant 228b (on-ground, e.g., at the cloud server 214). The corresponding second digital assistant 228b estimates or computes the takeoff time, taxi time, and flight time based on the various factors discussed above, and transmits these times to the first digital assistant 228a (on-board) for synchronization and further display in the cockpit.

According to yet another example, the digital assistant 228a (at the aircraft 104) is configured to generate an interface to receive obstacle information provided by the aircraft sensors 226 and to modify a trajectory of the aircraft avoiding detected obstacles (e.g., taxiing trajectory avoiding traffic at the airport) and to send updated trajectory information to the collaborative map 218a (at the aircraft 104). The digital assistant 228a (at the aircraft 104) is configured to notify the updated trajectory information to the corresponding second digital assistant 228b (on-ground, e.g., at the cloud server 214) for synchronization purpose. And the collaborative map 218a (at the aircraft 104) communicates with the corresponding second collaborative map 218b and the corresponding third collaborative map 218c (on-ground) for synchronization purposes.

It is apparent from what precedes that each of the aircraft equipment 201a and ground equipment 201b can receive new information from various sources (data from on-board sensors, weather data from a weather server, airport data from airport servers, and NOTAM information from NOTAM servers), and whichever instance of the collaborative map 218 or whichever instance of the digital assistant 228 processes the new information, each other instance of the collaborative map 218 or of the digital assistant 228 is automatically updated in accordance thanks to the synchronization in place.

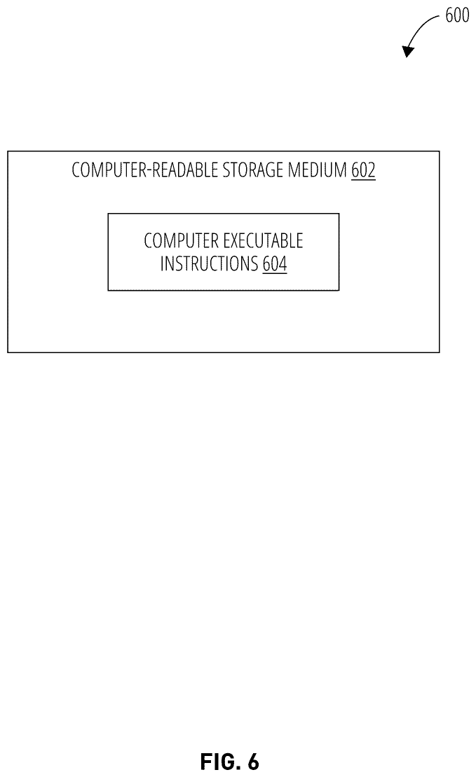

FIG. 6 illustrates an apparatus 600. Apparatus 600 comprises any non-transitory computer-readable storage medium 602 or machine-readable storage medium, such as an optical, magnetic or semiconductor storage medium. In various embodiments, apparatus 600 comprises an article of manufacture or a product. In some embodiments, the computer-readable storage medium 602 stores computer executable instructions with which one or more processing devices or processing circuitry can execute. For example, computer executable instructions 604 includes instructions to implement operations described with respect to any method, operation, logic flows, timing diagram, or embodiment described herein. The executable instructions 604 includes instructions to perform any function described above or any portion of the methods 400 or 500 described above.

Examples of computer-readable storage medium 602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 604 include any suitable type of code, such as source code, compiled code, interpreted code, executable code, static code, dynamic code, object-oriented code, visual code, and the like.

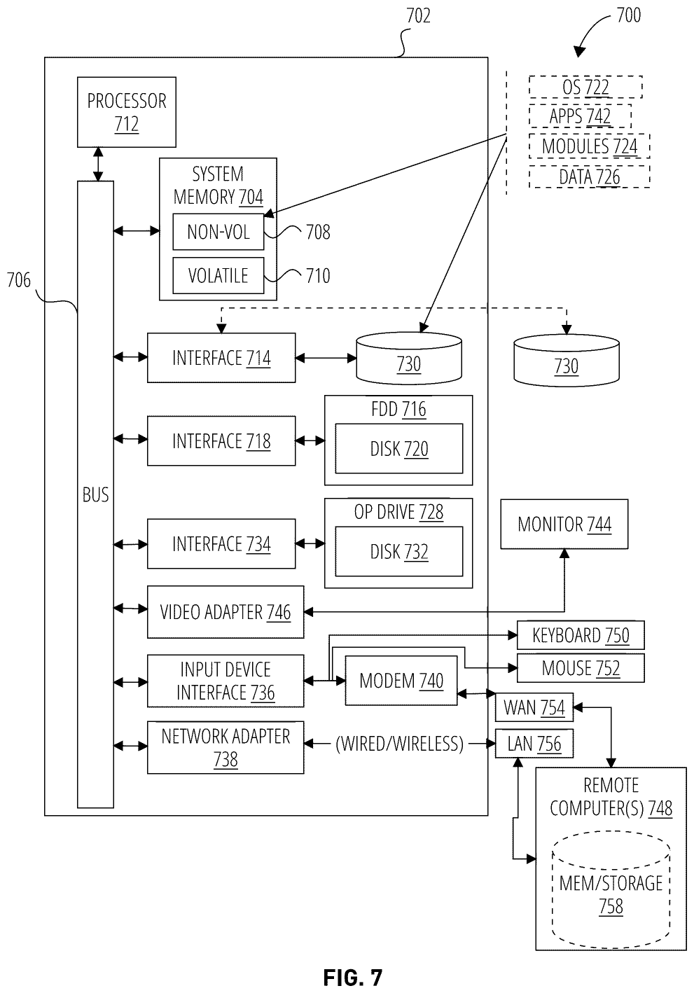

FIG. 7 illustrates an embodiment of an exemplary computer architecture 700 suitable for implementing various embodiments as previously described. In one embodiment, the computer architecture computer architecture 700 may include or be implemented as part of one or more systems or devices discussed herein. For example, the computer architecture 700 includes components that can implement one or more of the communication system 200, tablets, aircraft server 202, ATC server 212, cloud server 214, OCC server 216, and any other computing device described in this application.

As used in this application, the terms “system” and “component” are intended to refer to a computer-related entity, either hardware, a combination of hardware and software, software, or software in execution, examples of which are provided by the exemplary computer architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 700 includes various common computing elements, such as one or more processors, multi-core processors, co-processors, processing circuit(s), memory units, chipsets, controllers, peripherals, interfaces, oscillators, timing devices, video cards, audio cards, multimedia input/output (I/O) components, power supplies, and so forth. The embodiments, however, are not limited to implementation by the computer architecture 700.

As shown in FIG. 7, the computer architecture 700 includes a processor 712, a system memory 704 and a system bus 706. The processor 712 can be any of various commercially available processors or processor circuits.

The system bus 706 provides an interface for system components including, but not limited to, the system memory 704 to the processor 712. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile 708 and/or volatile 710. A basic input/output system (BIOS) can be stored in the non-volatile 708.

The computer 702 may include various types of computer-readable storage media in the form of one or more lower speed memory units, including an internal (or external) hard disk drive 730, a magnetic disk drive 716 to read from or write to a removable magnetic disk 720, and an optical disk drive 728 to read from or write to a removable optical disk 732 (e.g., a CD-ROM or DVD). The hard disk drive 730, magnetic disk drive 716 and optical disk drive 728 can be connected to system bus 706 the by an HDD interface 714, and FDD interface 718 and an optical disk drive interface 734, respectively. The HDD interface 714 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 708, and volatile 710, including an operating system 722, one or more applications 742, other program modules 724, and program data 726. In one embodiment, the one or more applications 742, other program modules applications 742, and program data 726 can include, for example, the various applications and/or components of the systems discussed herein.

A user can enter commands and information into the computer 702 through one or more wire/wireless input devices, for example, a keyboard 750 and a pointing device, such as a mouse 752. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 712 through an input device interface 736 that is coupled to the system bus 706 but can be connected by other interfaces such as a parallel port, IEEE 1394 serial port, a game port, a USB port, an IR interface, and so forth.

A monitor 744 or other type of display device is also connected to the system bus 706 via an interface, such as a video adapter 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory and/or storage device 758 is illustrated. The logical connections depicted include wired/wireless connectivity to a local area network 756 (LAN) and/or larger networks, for example, a wide area network 754 (WAN). Such LAN and WAN networking environments are commonplace in offices and companies, and facilitate enterprise-wide computer networks, such as intranets, all of which may connect to a global communications network, for example, the Internet.

When used in a local area network 756 networking environment, the computer 702 is connected to the local area network 756 through a wire and/or wireless communication network interface or network adapter 738. The network adapter 738 can facilitate wire and/or wireless communications to the local area network 756, which may also include a wireless access point disposed thereon for communicating with the wireless functionality of the network adapter 738.

When used in a wide area network 754 networking environment, the computer 702 can include a modem 740, or is connected to a communications server on the wide area network 754 or has other means for establishing communications over the wide area network 754, such as by way of the Internet. The modem 740, which can be internal or external and a wire and/or wireless device, connects to the system bus 706 via the input device interface 736. In a networked environment, program modules depicted relative to the computer 702, or portions thereof, can be stored in the remote memory and/or storage device 758. It will be appreciated that the network connections shown are exemplary and other means of establishing a communications link between the computers can be used.

The computer 702 is operable to communicate with wire and wireless devices or entities using the IEEE 1402 family of standards, such as wireless devices operatively disposed in wireless communication (e.g., IEEE 1402.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

### ADDITIONAL EXAMPLE EMBODIMENTS

In some embodiments, a communication system is provided, the communication system comprising electronic circuitry in an aircraft equipment onboard an aircraft and electronic circuitry in an on-ground equipment on the ground, wherein the communication system is configured to use a collaborative map having a graphic user interface that includes a plurality of digital layers that each display a different interface view and to generate a digital assistant to optimize missions of the aircraft on ground and in flight. Furthermore, the electronic circuitry of the aircraft equipment is configured to generate a first instance of the collaborative map on a first human-machine interface within the cockpit of the aircraft for one or more pilots to view and interact with, and to generate a first instance of the digital assistant on a second human-machine interface within the cockpit of the aircraft for the one or more pilots to view and interact with. Furthermore, the electronic circuitry of the on-ground equipment is configured to generate at least one second instance of the collaborative map on at least one respective human-machine interface for one or more operators to view and interact with, and to generate a second instance of the digital assistant. Furthermore, the electronic circuitry of the on-ground equipment is configured to manage communications between the at least one second instance of the collaborative map and the second instance of the digital assistant for interactions thereof. Furthermore, the aircraft equipment and the on-ground equipment are configured to cooperate to manage communications between the first instance of the collaborative map and the at least one second instance of the collaborative map for synchronization thereof and to manage communications between the first instance of the digital assistant and the second instance of the digital assistant for synchronization thereof.

Thus, thanks to the synchronized instances of the collaborative map and of the digital assistant, the pilot workload is reduced and exchanges between ground structures and the aircraft are accelerated. Indeed, all of them share the same view of the aircraft's situation with synchronized tools.

According to an embodiment, a graphic user interface of the first instance of the collaborative map is displayed on a first aircraft tablet within the cockpit of the aircraft and a graphic user interface of the digital assistant is displayed on a second aircraft tablet within the cockpit of the aircraft.

Furthermore, the first aircraft tablet and the second aircraft tablet are each in communication with a server onboard the aircraft and the server exchanges data with the first aircraft tablet and the second aircraft tablet to display respectively for the collaborative map and the digital assistant.

According to an embodiment, the collaborative map includes a layers-visualization manager that includes several layers among:
a visual display of the aircraft;
a static aeronautical layer with airport ways, clearance points, and a digital terrain model;
a dynamic aeronautical layer displaying dynamic aeronautical data including weather data, 3-dimensional maps, traffic in-flight and on ground;
a message layer for Notice to Airmen NOTAM data;
a trajectory layer with aircraft trajectories inflight and on-ground;
a dialog layer displaying a dialog windows depicting present communication data between aircraft's pilots, Air Traffic Control, and Operations Control Center;
a layer displaying proposal data to manage communications between aircraft's pilots, Air Traffic Control, and Operations Control Center;
a feedback layer displaying feedback data and information from the aircraft's pilots to Air Traffic Control and Operations Control Center;
a communication layer connected with the digital assistant to display optimizations, predictions, and monitoring performed by the digital assistant; and
a performance layer depicting uses of on-ground server resources and on-board server resources to provide the collaborative map.

According to an embodiment, the collaborative map includes a clearance and flight plan manager configured to enter and display clearance messages from Air Traffic Control, and to send clearance requests from aircraft's pilots to Air Traffic Control, and to manage and edit flight plans for the aircraft.

According to an embodiment, the digital assistant includes optimization functions to optimize a flight plan and/or to optimize on-ground taxi phase.

According to an embodiment, the digital assistant includes prediction functions to make predictions regarding takeoff time, taxi time, and flight time of the aircraft, based on flight plan and weather and Notice to Airmen NOTAM information.

According to an embodiment, one second instance of the collaborative map is implemented by a server at Air Traffic Control, one second instance of the collaborative map is implemented by a server at Operations Control Center, and the second instance of the digital assistant is implemented by a cloud server.

According to an embodiment:
the first instance of the collaborative map is configured to generate an interface to receive clearance indications from the one second instance of the collaborative map implemented by a server at Air Traffic Control and to display the received clearance indications;
the one second instance of the collaborative map implemented by the server at Air Traffic Control is configured to generate and send clearance indications to the first instance of the collaborative map for entering a runway or for initiating taxi phase; and
the one second instance of the collaborative map implemented by the server at Operations Control Center is synchronously modified in accordance.

According to an embodiment:
the first instance of the collaborative map is configured to generate an interface to receive a new flight plan from the one second instance of the collaborative map implemented by the server at Operations Control Center and modify an existing flight plan;
the one second instance of the collaborative map implemented by the server at Operations Control Center is configured to generate and send the new flight plan proposal to the first instance of the collaborative map for an approach phase of the aircraft and/or to send the new flight plan proposal to the first instance of the collaborative map for avoiding a weather hazard or contrail hazard, and
the one second instance of the collaborative map implemented by the server at Air Traffic Control is synchronously modified in accordance.

According to an embodiment:
the one second instance of the collaborative map implemented by the server at Air Traffic Control is configured to determine that the aircraft is cleared for taxiing to a take-off runway;
the one second instance of the collaborative map implemented by the server at Air Traffic Control is configured to generate a clearance message and to send the clearance message to the one second instance of the collaborative map implemented by the server at Operations Control Center;
the one second instance of the collaborative map implemented by the server at Operations Control Center is configured to receive the clearance message for the aircraft to begin taxiing and to calculate and optimize an on-ground trajectory of the aircraft for taxiing to the runway based on airport data, including data on other aircraft and their departure times;
the one second instance of the collaborative map implemented by the server at Operations Control Center is configured to transmit the on-ground trajectory to the first instance of the collaborative map and to the one instance of the collaborative map implemented by the server at Air Traffic Control for synchronization and further display;
the one second instance of the collaborative map implemented by the server at Operations Control Center is configured to transmit the on-ground trajectory to the second instance of the digital assistant; and
the second instance of the digital assistant is configured to compute takeoff time, taxi time, and flight time, and to transmit these times to the first instance of the digital asistant for synchronization and further display in the cockpit.

According to an embodiment:
the first instance of the digital assistant is configured to generate an interface to receive obstacle information provided by aircraft sensors and to modify a trajectory of the aircraft avoiding detected obstacles and to send updated trajectory information to the first instance of the collaborative map
the first instance of the digital assistant is configured to notify the updated trajectory information to the second instance of the digital assistant for synchronization
the first instance of the collaborative map is configured to communicate with the at least one second instance of the collaborative map for synchronization with respect to the updated trajectory information.

According to another embodiment, a communication method is disclosed, the communication method being performed by a communication system comprising aircraft equipment onboard an aircraft and an on-ground equipment on the ground, wherein the method comprises using a collaborative map having a graphic user interface that includes a plurality of digital layers that each display a different interface view and generating a digital assistant to optimize missions of the aircraft on ground and in flight. Furthermore, the method comprises generating a first instance of the collaborative map on a first human-machine interface within the cockpit of the aircraft for one or more pilots to view and interact with, and generating a first instance of the digital assistant on a second human-machine interface within the cockpit of the aircraft for the one or more pilots to view and interact with. Furthermore, the method comprises generating at least one second instance of the collaborative map on at least one respective human-machine interface for one or more operators to view and interact with, and generating a second instance of the digital assistant. Furthermore, the method comprises managing communications between the at least one second instance of the collaborative map and the second instance of the digital assistant for interactions thereof. Furthermore, the method comprises managing communications between the first instance of the collaborative map and the at least one second instance of the collaborative map for synchronization thereof and managing communications between the first instance of the digital assistant and the second instance of the digital assistant for synchronization thereof.

Some embodiments of the disclosed system may be implemented, for example, using a storage medium, a computer-readable medium or an article of manufacture which may store an instruction or a set of instructions that, when executed by a machine (e.g., processor, processing circuit, or microcontroller), may cause the machine to perform a method and/or operations in accordance with embodiments of the disclosure. In addition, a server or database server may include machine readable media configured to store machine executable program instructions. Such a machine may include, for example, any suitable processing platform, computing platform, computing device, processing device, computing system, processing system, computer, processor, or the like, and may be implemented using any suitable combination of hardware, software, firmware, or a combination thereof and utilized in systems, subsystems, components, or sub-components thereof. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A communication system comprising:
a processing circuit coupled to a memory having executable instructions stored thereon, where, in response to executing the instructions, the processing circuit is configured to:
generate a collaborative map on a first user interface of a first computing device within a cockpit of an aircraft for a pilot to view and interact with, the collaborative map including a plurality of digital layers that each display a different interface view to the pilot;
generate a digital assistant on a second user interface of a second computing device within the cockpit of the aircraft for the pilot to view and interact with, the digital assistant to optimize missions of the aircraft on ground and in flight;
manage communication of data between the collaborative map and a corresponding second collaborative map managed by a third computing device to synchronize data displayed on the collaborative map and the corresponding second collaborative map; and
manage communication of data between the digital assistant and a corresponding second digital assistant managed by a fourth computing device to synchronize data displayed on the digital assistant and the corresponding second digital assistant.

2. The communication system of claim 1, wherein the communication system is configured to receive data from a network of an airline associated with the aircraft, systems onboard the aircraft, or data suppliers associated with the airline and display the data on the collaborative map, the digital assistant, the corresponding second collaborative map, or the corresponding second digital assistant.

3. The communication system of claim 2, wherein the data from the network of the airline includes data from an Operations Control Center (OCC) of the airline, including a takeoff time, a ground trajectory, and a flight path or flight trajectory of the aircraft;
wherein data captured by systems onboard the aircraft includes data captured by one or more sensors of the aircraft, data from an automatic dependent surveillance-broadcast (ADS-B) system onboard the aircraft, and an ADS-contracts (ADS-C) onboard the aircraft; and
wherein data from data suppliers includes weather data from a weather server, airport data from airport servers, and Notice to Air Men (NOTAM) data.

4. The communication system of claim 1, wherein the collaborative map includes a clearance and flight plan manager configured to enter and display clearance messages from Air Traffic Control (ATC), and to send clearance requests from an aircraft to ATC, and to manage and edit flight plans for the aircraft.

5. The communication system of claim 1, wherein the plurality of digital layers include one or more of:
a visual display of the aircraft;
a static aeronautical layer with airport ways, clearance points, and a digital terrain model;
a dynamic aeronautical layer displaying dynamic aeronautical data including weather data, 3-dimensional maps, traffic in-flight and on ground
a message layer for Notice to Airmen (NOTAM) data;
a trajectory layer with aircraft trajectories in-flight and on-ground;
a dialog layer displaying dialog windows depicting present communication data between the pilots, air traffic control (ATC), and the OCC of the airline;
a layer displaying proposal data to manage communications between the pilots, ATC, and the OCC;
a feedback layer displaying feedback data and information from the aircraft's pilots to the ATC and the OCC;
a communication layer connected with the digital assistant, the communication layer to display optimizations, predictions, and monitoring of the digital assistant; and
a performance layer depicting uses on ground servers and aircraft local servers to provide the collaborative map.

6. The communication system of claim 1, wherein the collaborative map is configured to provide tools to manage communication between the collaborative map and the corresponding second collaborative map managed by the third computing device, including the collaborative map being configured to:
provide and maintain a secure communication channel between the collaborative map and the corresponding second collaborative map;
generate interfaces to accelerate a clearance process with text-based enablers for the pilot to select; and
generate interfaces to propose a new flight plan during an approach phase of the aircraft; and
wherein the corresponding second collaborative map managed by the third computing device is configured to generate interfaces to accept the new flight plan data from the collaborative map.

7. The communication system of claim 1, wherein the collaborative map is further configured to provide tools to manage communication between the collaborative map and the corresponding third collaborative map managed by the fourth computing device, including the collaborative map being configured to:
provide and maintain a secure communication channel between the collaborative map and the corresponding third collaborative map; and
generate an interface to receive a new flight plan from the corresponding third collaborative map and modify an existing one; and
wherein the corresponding third collaborative map managed by the fourth computing device is configured to:
send a new flight plan proposal to the collaborative map for an approach phase of the aircraft; and
send a new flight plan proposal to the collaborative map for avoiding a weather hazard or contrail hazard.

8. The communication system of claim 1, wherein the digital assistant is configured to compute flight predictions and provide outputs to the pilots to allow a continuous monitoring of tasks; and
wherein the digital assistant is configured to optimize a flight plan or to optimize an on-ground taxi phase of the aircraft.

9. The communication system of claim 1, wherein the digital assistant is configured to make predictions regarding takeoff, taxi time, and flight time of the aircraft, based on flight plan, weather data, and NOTAM data.

10. The communication system of claim 1, wherein the digital assistant is configured to:
create a flight plan route for the aircraft;
create a digital folder with identification of NOTAM information and weather information relevant to the flight plan;
extract weather and NOTAM information from the digital folder as well as documentation data;
generate a performance forecast based on the weather and NOTAM information and the documentation data;
predict a takeoff time, taxi time, and flight time based on the flight plan, the weather and NOTAM information, and the documentation data;
predict a trajectory of the aircraft based on the extracted data and the predicted takeoff time, taxi time, and flight time; and
modify the trajectory in real time depending on a weather event during the flight and other external events.

11. The communication system of claim 1, wherein the collaborative map is displayed on a first tablet within the cockpit of the aircraft and the digital assistant is displayed on a second tablet within the cockpit;
wherein the first tablet and the second tablet are each in communication with an aircraft server onboard the aircraft, wherein the collaborative map and the digital assistant are implemented using the aircraft server, which is configured to exchanges data with the first tablet and the second tablet to display for the collaborative map and the digital assistant; and
wherein the aircraft includes a database onboard, the database being in communication with the aircraft server, the aircraft server being configured to extract data from the database to make predictions and provide data to the collaborative map and the digital assistant.

12. The communication system of claim 11, wherein the corresponding second collaborative map is displayed on a first tablet on ground with air traffic control (ATC) and implemented by an ATC server, wherein the aircraft server and the ATC server are configured to communicate with each other to synchronize data with each other and communicate messages between the pilot and ATC operators;
wherein the corresponding second digital assistant is maintained in a cloud server in communication with the aircraft server and is synchronized with the digital assistant onboard the aircraft;
wherein a corresponding third collaborative map is displayed on a fourth tablet associated with an operations control center (OCC) of the airline, and is implemented using an OCC server; and
wherein the aircraft server, ATC server, and OCC server communicate with each other over a wireless communications network to synchronize the collaborative map on the aircraft, the corresponding second collaborative map associated with the ATC, and the corresponding third collaborative map associated with the OCC.

13. The communication system of claim 11, wherein the processing circuit is configured to generate a first digital layer of the plurality of digital layers of the collaborative map, the first digital layer including a first interface to receive a clearance indication from the corresponding second collaborative map and to display the received clearance indication;
wherein the corresponding second collaborative map implemented by the ATC server associated with the ATC is configured to generate and send the clearance indication to the collaborative map for entering a runway or for initiating a taxi phase.

14. The communication system of claim 11, wherein the corresponding second collaborative map implemented by the ATC server is configured to determine that the aircraft is cleared for taxiing to a take-off runway;
wherein the corresponding second collaborative map implemented by the ATC server is configured to generate a clearance message and to send the clearance message to the corresponding third collaborative map implemented by the OCC server;
wherein the corresponding third collaborative map implemented by the OCC server is configured to receive the clearance message for the aircraft to be taxiing and to calculate and optimize an on-ground trajectory of the aircraft for taxiing to the runway based on airport data, including data on other aircraft and their departure times;
wherein the corresponding third collaborative map implemented by the OCC server is configured to transmit the on-ground trajectory to the collaborative map implemented using the aircraft server onboard the aircraft and to the corresponding second collaborative map implemented by the ATC server for synchronization and further display;
wherein the corresponding third collaborative map implemented by the OCC server is configured to transmit the on-ground trajectory to the corresponding second digital assistant maintained in the cloud server;
wherein the corresponding second digital assistant is configured to compute a takeoff time, taxi time, and flight time based on the on-ground trajectory, airport data, aircraft data about the aircraft, and a flight plan of the aircraft; and
wherein the corresponding second digital assistant is configured to send the takeoff time, taxi time, and flight time to the aircraft server for display on the digital assistant implemented by the aircraft server.

15. The communication system of claim 11, wherein the processing circuit is configured to generate an interface for the digital assistant to receive obstacle information received from a sensor onboard the aircraft;
wherein the digital assistant is configured to modify a flight plan or trajectory of the aircraft to avoid a detected obstacle and to send the modified flight plan or trajectory to the collaborative map; and
wherein the digital assistant is configured to communicate the modified flight plan or trajectory of the aircraft to the corresponding second digital assistant; and
wherein the collaborative map is configured to communicate the modified flight plan or trajectory of the aircraft to the corresponding second collaborative map or the corresponding third collaborative map.

16. An aircraft communication method comprising:
generating, by a processing circuit, a collaborative map on a first user interface of a first computing device within a cockpit of an aircraft for a pilot to view and interact with, the collaborative map including a plurality of digital layers that each display a different interface view to the pilot;
generating, by the processing circuit, a digital assistant on a second user interface of a second computing device within the cockpit of the aircraft for the pilot to view and interact with, the digital assistant to optimize missions of the aircraft on ground and in flight;
managing, by the processing circuit, communication of data between the collaborative map and a corresponding second collaborative map managed by a third computing device to synchronize data displayed on the collaborative map and the corresponding second collaborative map; and
managing communication of data between the digital assistant and a corresponding second digital assistant managed by a fourth computing device to synchronize data displayed on the digital assistant and the corresponding second digital assistant.

17. The method of claim 16, wherein the method further includes receiving data from a network of an airline associated with the aircraft, systems onboard the aircraft, or data suppliers associated with the airline and display or the data on the collaborative map, the digital assistant, the corresponding second collaborative map, or the corresponding second digital assistant;
wherein the data from the network of the airline includes data from an Operations Control Center (OCC) of the airline, including a takeoff time, a ground trajectory, and a flight path or flight trajectory of the aircraft;
wherein data captured by systems onboard the aircraft includes data captured by one or more sensors of the aircraft, data from an automatic dependent surveillance-broadcast (ADS-B) system onboard the aircraft, and an ADS-contracts (ADS-C) onboard the aircraft; and
wherein data from data suppliers includes weather data from a weather server, airport data from airport servers, and Notice to Air Men (NOTAM) data.

18. The method of claim 16, wherein the collaborative map includes a clearance and flight plan manager configured to enter and display clearance messages from Air Traffic Control (ATC), and to send clearance requests from an aircraft to ATC, and to manage and edit flight plans for the aircraft.

19. The method of claim 18, wherein the plurality of digital layers include one or more of:
a visual display of the aircraft;
a static aeronautical layer with airport ways, clearance points, and a digital terrain model;
a dynamic aeronautical layer displaying dynamic aeronautical data including weather data, 3-dimensional maps, traffic in-flight and on ground;
a message layer for Notice to Airmen (NOTAM) data;
a trajectory layer with aircraft trajectories in-flight and on-ground;
a dialog layer displaying dialog windows depicting present communication data between the pilots, air traffic control (ATC), and the OCC of the airline;
a layer displaying proposal data to manage communications between the pilots, ATC, and the OCC;
a feedback layer displaying feedback data and information from the aircraft's pilots to the ATC and the OCC;
a communication layer connected with the digital assistant, the communication layer to display optimizations, predictions, and monitoring of the digital assistant; and
a performance layer depicting uses on ground servers and aircraft local servers to provide the collaborative map.

20. A non-transitory computer-readable storage medium having executable instructions stored thereon, which when executed by a processing circuit of a computing device configures the computing device to:
generate a collaborative map on a first user interface of a first computing device within a cockpit of an aircraft for a pilot to view and interact with, the collaborative map including a plurality of digital layers that each display a different interface view to the pilot;
generate a digital assistant on a second user interface of a second computing device within the cockpit of the aircraft for the pilot to view and interact with, the digital assistant to optimize missions of the aircraft on ground and in flight;
manage communication of data between the collaborative map and a corresponding second collaborative map managed by a third computing device to synchronize data displayed on the collaborative map and the corresponding second collaborative map; and
manage communication of data between the digital assistant and a corresponding second digital assistant managed by a fourth computing device to synchronize data displayed on the digital assistant and the corresponding second digital assistant.
